(19) United States
(12) Patent Application Publication
(10) Pub. No.: US 2003/0005098 A1
(43) Pub. Date: Jan. 2, 2003

(54) Method and apparatus for using dynamic grouping data to group attributes relating to computer systems

(75) Inventors: David Michael Koelle, Marlborough, MA (US); Jeffrey Phillip Snover, Woodinville, WA (US); Brian James Tarbox, Littleton, MA (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY

(21) Appl. No.: 09/894,065

(22) Filed: Jun. 28, 2001

(51) Int. Cl. G06F 15/177; G06F 15/173; G06F 15/16

(52) U.S. Cl. 709/223; 709/221; 709/245

(57) ABSTRACT

A method, apparatus, and computer implemented instructions for grouping based on attributes in a data processing system. Messages are sent indicating an availability of a set of attributes relating to data processing systems in which the attributes are used to create. A request is received from a requester to generate a group using selected attributes from the set of attributes. A group is generated based on the selected attributes. The group is returned to the requester.

### BACKGROUND OF THE INVENTION

1. Technical Field

The present invention relates generally to an improved data processing system, and in particular to a method and apparatus for managing data processing systems. Still more particularly, the present invention provides a method, apparatus, and computer implemented instructions for grouping devices and data processing systems using dynamic grouping data.

2. Description of Related Art

Many computer networks tend to be extremely large, especially those for large businesses. For example, a large network is one that contains thousands of nodes or more. Such networks are routine in business today, and as the number of network nodes reaches into the millions, they become less manageable through existing means. Another example of a large network is the Internet. The Internet has become a cultural fixture as a source of both information and entertainment. Many businesses are creating Internet sites as an integral part of their marketing efforts. Many federal, state, and local government agencies are also employing Internet sites for informational purposes. Additionally, some businesses may operate and manage domain name servers or server farms in providing services to users.

These types of networks make managing the networks difficult without appropriate grouping mechanisms. Currently available grouping mechanisms involve defining a set of criteria to be matched and a process for the ongoing evaluation of this set of criteria. These processes are used to insure that a system maintains a correct identification of members in the set as changes occur in the network. These processes usually receive attributes for computer systems and generate groups based on the attributes. These attributes may include, for example, clock speed, processor type, number of processors, amount of memory, and hard drive space. The computer systems provide the grouping mechanism with a preset set of attributes. The data received from these computer systems are used by the grouping mechanism to generate groups for use in managing the network. For example, an operator or network administrator may create a group of computer systems that act as domain name system (DNS) servers. Then, when needed the operator may quickly identify which computer systems are DNS servers.

Currently available mechanisms rely on a static definition of grouping attributes and are proprietary. With these systems, a user is unable to generate groupings based on new attributes without having the grouping software being reconfigured to use the new attributes.

Therefore, it would be advantageous to have an improved method and apparatus for generating groupings without relying on static definitions of grouping attributes.

### SUMMARY OF THE INVENTION

The present invention provides a method, apparatus, and computer implemented instructions for grouping based on attributes in a data processing system. Messages are sent indicating an availability of a set of attributes relating to data processing systems in which the attributes are used to create. A request is received from a requester to generate a group using selected attributes from the set of attributes. A group is generated based on the selected attributes. The group is returned to the requester.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which the present invention may be implemented;

FIG. 2 is block diagram of a data processing system that may be implemented as a server in accordance with a preferred embodiment of the present invention;

FIG. 3 is a block diagram illustrating a data processing system in which the present invention may be implemented;

FIG. 4 is a diagram illustrating data flow used in exchanging data used for dynamic grouping in accordance with a preferred embodiment of the present invention;

FIG. 5 is a diagram of data flow used in generating a group in accordance with a preferred embodiment of the present invention;

FIG. 6 is a flowchart of a process used for creating and broadcasting attributes in accordance with a preferred embodiment of the present invention;

FIG. 7 is a flowchart of a process used for processing the request for a group in accordance with a preferred embodiment of the present invention;

FIG. 8 is a flowchart of a process used for processing a query to create a group in accordance with a preferred embodiment of the present invention; and

FIG. 9 is a flowchart of a process used for requesting a group in accordance with a preferred embodiment of the present invention.

### DETAILED DESCRIPTION OF THE PREFERRED EMBODIMENT

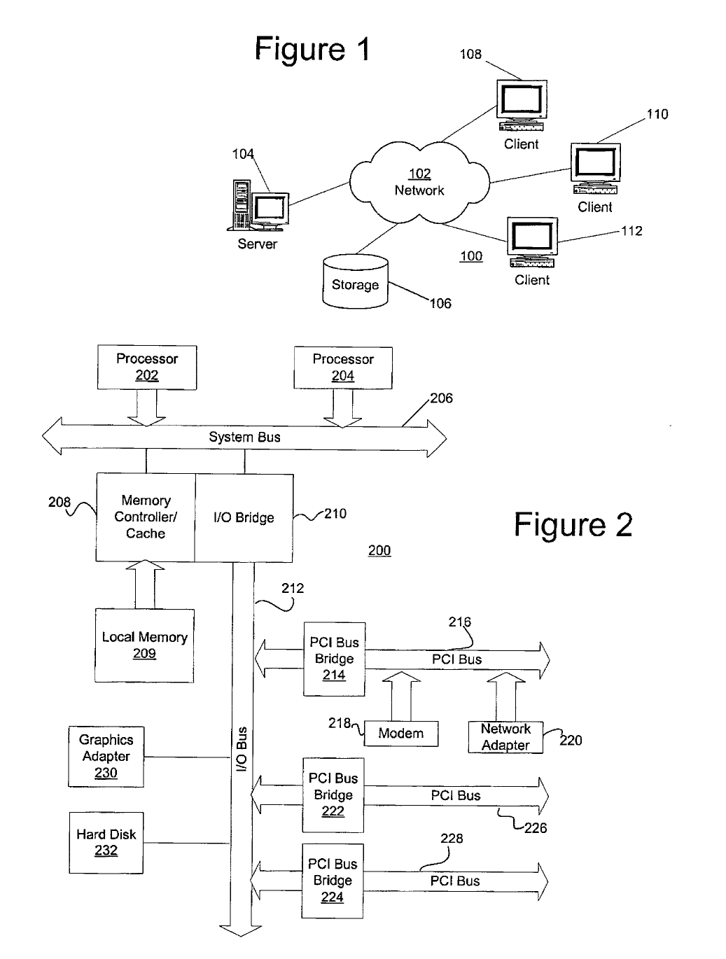

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, N.Y., running the Advanced Interactive Executive (AIX) operating system or LINUX operating system.

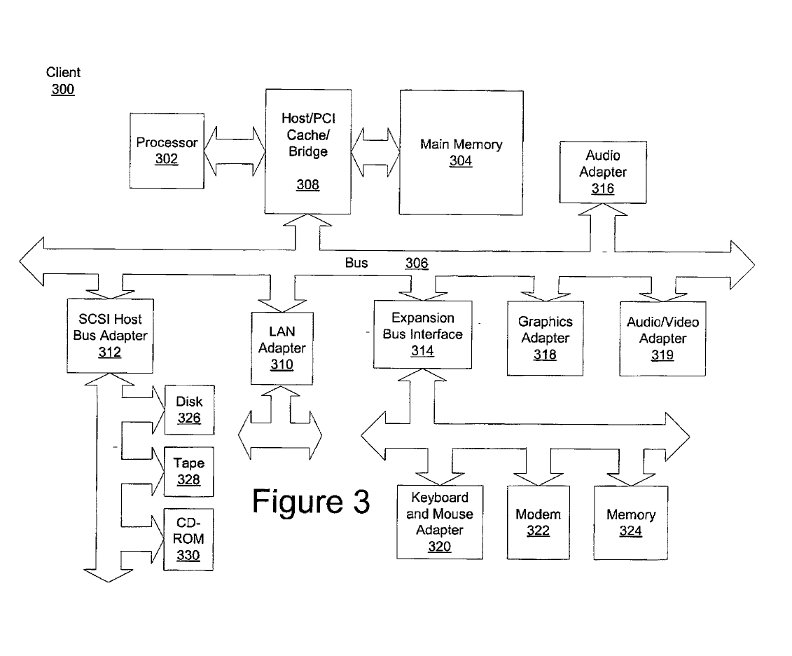

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide nonvolatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

The present invention provides a method, apparatus, and computer implemented instructions for allowing flexible extensions to a grouping process. The mechanism of the present invention allows defining meta-data, which describes which attribute may be searched and which attributes may be returned. Meta-data is data that describes other data. Data dictionaries and repositories are examples of meta-data. The meta tag that describes the content of a Web page is called meta-data. The term may also refer to any file or database that holds information about another database's structure, attributes, processing or changes.

The present invention realizes that is impossible to anticipate a range of attributes, which may be considered interesting to a user or a program. The mechanism of the present invention allows the dynamic addition of new attributes. With this mechanism, new programs may become suppliers of grouping data, which increases the value of both of the new programs and the overall system.

The meta-data in these examples is common to all suppliers of data, making it possible to create new higher order groups by performing operations against multiple groups at a time. For example, a user could obtain a group of all machines that are e-mail servers, and a group of all machines that have a low-bandwidth network connection. The user can then intersect these two groups, and determine the machines that require a connection upgrade before the latest e-mail server software is installed on them. This combines information gathered from an inventory application, which machines are e-mail servers, with information gathered from a network discovery application, which machines have low-bandwidth connections. By “common”, it is meant that the exchange of meta-data and membership information is done in the same way, regardless of the data providers; that is, there are no barriers unique to any particular data provider that have to be surmounted before data can be exchanged.

The mechanism of the present invention allows services to “advertise” attributes that may be used to generate groups. This feature allows any type of service, even those that are unknown, to supply any piece of data as a grouping attribute. The user of the grouping service can then ask for a group to be created and receive the membership of the group.

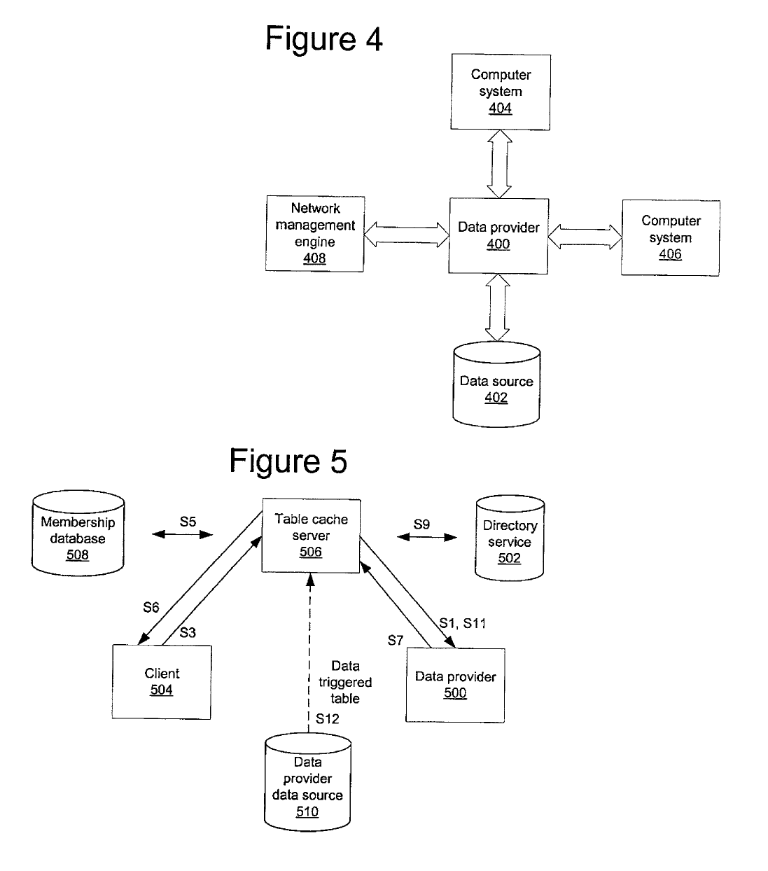

Turning next to FIG. 4, a diagram illustrating data flow used in exchanging data used for dynamic grouping is depicted in accordance with a preferred embodiment of the present invention. FIG. 4 illustrates components used to group attributes according to the present invention.

In this example, data provider 400 advertises or sends messages identifying the names of data for which data provider 400 is able to use in creating groups. Data provider 400 may be implemented in software in a data processing system, such as server 104 in FIG. 1. The names of data may include, for example, a processor type, processor clock speed, an amount of memory, memory type, bus system, bus clock speed, storage capacity, connection, video card specification, and operating system. In the depicted implementation, no special format to the exchanged data is present. Rather, Java objects are sent through remote methods. For example, when a data provider advertises its metadata, it remotely calls a method in network management engine 408, “advertiseData”, and passes objects representing the meta-data. The same procedure is true for sending requests to create a group (the remote method call is “createGroup”), and group membership information (the remote method call is “sendMembership”). The attributes, which may be used to create groups, are stored in data source 402. Additionally, attribute information received from data processing systems also may be stored within data source 402. In these examples, data source 402 is a database.

Data provider 400 receives attribute information from computer system 404 and computer system 406 in these examples. The attribute information may be added to data source 402 using various mapping mechanisms. No particular format is required in these examples. Any format recognized or usable in data source 402 may be employed. A standard ASCII string using a category, data scheme may be employed. Data provider 400 may receive information in various forms and map the information into an appropriate form for data source 402. For example, data provider 400 may provide information on a system name and memory size may insert the system name and the memory size as an integer in data source 402. Processes within data provider 400 may be used to map information received from a computer system in to a form for storage in data source 402. These computer systems may be clients or servers, such as data processing system 200 in FIG. 2 or data processing system 300 in FIG. 3. Only two computer systems are shown in these examples for purposes of illustration. In actual practice, meta-data may be received from hundreds or thousands of computer systems.

The advertisement of names of data, which may be used to create groups, is received by network management engine 408 in these examples. Network management engine 408 is a program or application, which may request a group from data provider 400. The request is based on the advertisement made by data provider 400. In these examples, the user is presented with the names of advertised data, and may select any of the available advertised data when creating groups. Network management engine 408 then takes the user's selections and constructs an object to use in calling the remote method in data provider 400 for performing the appropriate action. In this example, network management engine 408 generates a request to identify all computers with available hard drive space of more than 40 megabytes. In response to this request, data provider 400 returns a group or set of results that fit the required characteristics for the hard drive space attribute. This set of results may be, for example: {system25.dev.tivoli.com, phi.dev.tivoli.com}, which are DNS names in this example. Other mechanisms may be used for obtaining names. The identified systems need not be DNS servers. The different types of groups that may be created depend on the particular implementation. These groups may be, for example, groups of users, groups of applications, or groups of data processing systems.

In these examples, data provider 400 includes processes for generating queries against items or entries in a database, such as data source 402. The results received from data source 402 form a group meeting the query, which is based on the request for a new group. This result is place into a format for use by the requester.

In Java, the result returned from a database query is stored in a ResultSet object, part of Java's java.sql package. Data provider 400 traverses this ResultSet to generate a vector of objects, which are forwarded to the requester via the method that is used to communicate the membership of the SmartSet to the requester.

With reference now to FIG. 5, a diagram of data flow used in generating a group is depicted in accordance with a preferred embodiment of the present invention. FIG. 5 is a more detailed illustration of data flow used in requesting a group in response to advertisement of attributes, which may be used to generate groups. In particular these groupings may be used by a network management engine. SmartSets are groupings that allow a user to group network resources that should be managed similarly and apply policies to these groups. As a result, a user can manage a set of resources as though it were a single device.

Data Provider 500 advertises an ability to participate in a grouping system such as SmartSets, and also advertises the type of information contained in its database (step S1). This advertisement is received by the table cache server 506 and stored in directory service 502 (Step S9). Directory service 502 contains smartset metadata in this example. Client 504 requests that a group be created based on the advertised capabilities by asking table cache server 506 (Step S3). If the group already exists, table cache server 506 obtains the membership information from its own data source, membership database 508, and sends it to client 504 (Steps S5 and S6). Table cache server 506 holds grouping data so more than one client, such as client 504 can access an already constructed SmartSet, if one already exists. If the group does not exist, table cache server 506 asks data provider 500 to create the group (Step S7). Data provider 500 creates a group by making calls to data provider data source 510 (Step S8). This data source is not required to be a database; it may be any data source that is capable of determining that data belongs to a requested set. The membership data is sent from data provider 500 to the table cache server 506 (Step S11), and table cache server 506 stores the membership data in its data source (Step S5) so the next time a similar group is requested, the membership calculations do not have to be performed again, unless explicitly requested. Table cache server 506 then sends the membership information to client 504 (Step S6). In some special cases, updates to data provider data source 510 may be sent directly to table cache server 506, bypassing the need for table cache server 506 to make requests to the data provider 500 (Step S12). Step S12 is an optional step in these examples. Client 504 in this diagram is an instance of network management engine 408 in FIG. 4. Directory service 502 serves as the communication backbone.

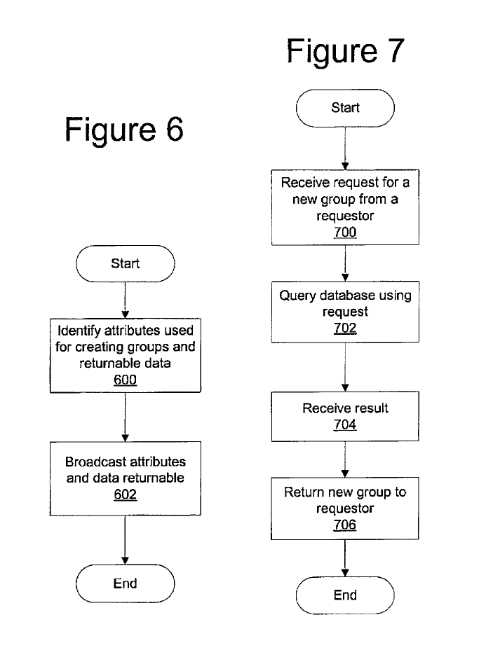

Turning next to FIG. 6, a flowchart of a process used for creating and broadcasting attributes is depicted in accordance with a preferred embodiment of the present invention. The process illustrated in FIG. 6, may be implemented in a data provider, such as data provider 400 in FIG. 4.

The process begins by identifying attributes used for creating group and returnable data (step 600). This step includes user input from a user, such as a programmer who creates the data provider to advertise the data. This step actually occurs as part of the creation of the program, in this example. Next, the attributes and returnable data are broadcast (step 602) with the process terminating thereafter. In the depicted examples, the broadcast is made to all devices on a network.

With reference now to FIG. 7, a flowchart of a process used for processing the request for a group is depicted in accordance with a preferred embodiment of the present invention. The process illustrated in FIG. 7 may be implemented in data provider, such as data provider 400 in FIG. 4.

The process begins by receiving a request for a new group from a requester (step 700). No particular format is used in generating requests. Requestors will have to know the application programming interface (API) for this brand of data providers in general, to know that methods like “advertiseData”, “createGroup”, and “sendMembership” exist. “advertiseData” is a method for the data provider to communicate the attributes, which may be used for grouping to the Table cache server. Next, “createGroup” is a method for the requestor to request that the Table cache server obtain the members of a SmartSet, which uses calls to the database. “sendmembership” is a method for the Table cache server to communicate the membership of a SmartSet to the requester. In this particular case, the request is obtained through a “createGroup” remote method call. Again, Java objects are used for passing the actual data through these method calls. The components of the Java objects are also part of the API.

A query is made to a database using the request (step 702). This request may be, for example, a request for a group of all computers having a UNIX operating system. A result is returned from the database (step 704). In this example, a remote method is called, which contains a Java object that describes the membership information. No special formatting is required. The Java object for describing membership information is defined in the API and simply consists of an array of strings. Then, the new group is returned to the requestor (step 706) with the process terminating thereafter.

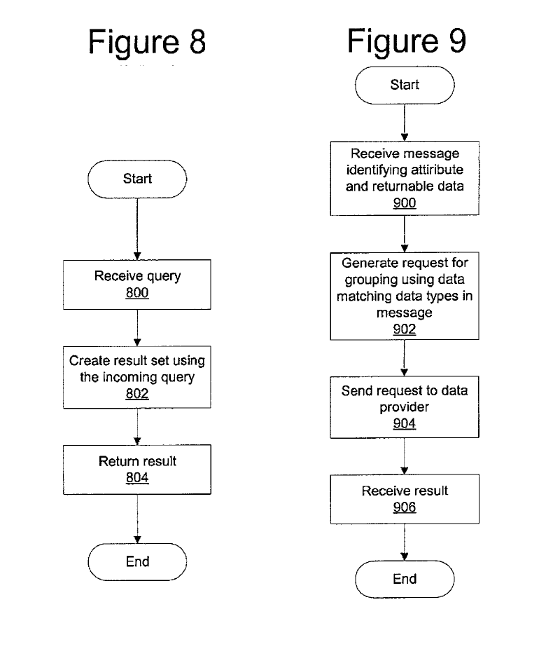

With reference now to FIG. 8, a flowchart of a process used for processing a query to create a group is depicted in accordance with a preferred embodiment of the present invention. This process may be implemented in a database, such as data source 402 in FIG. 4.

The process begins by receiving a query from a requester (step 800). For example, the query may be to select entries from the database in which the memory size is greater than 128. In response to receiving the query, a result is created using the query (step 802). The result, in these examples, may be an object containing entries matching the query. For example, the set may be “system25.dev.tivoli.com, phi.dev.tivoli.com”, which are DNS names. The result is returned to the requestor (step 804) with the process terminating thereafter.

Turning next to FIG. 9, a flowchart of a process used for requesting a group is depicted in accordance with a preferred embodiment of the present invention. The process illustrated in FIG. 9 may be implemented in software, such as network management engine 408 in FIG. 4.

The process begins by receiving a message, identifying attributes and data returnable (step 900). This message is received from a data provider. Next, a request is generated for grouping using data matching attributes in the message (step 902). A request is then sent to the data provider broadcasting the message (step 904). A result is received (step 906) with the process terminating thereafter. The result may be a group containing zero or more computer systems, in this example.

Thus, the present invention provides an improved method, apparatus, and computer implemented instructions for grouping based on attributes that may be dynamically defined. This mechanism allows for management of networks based on a dynamic set of attributes that may be changed as the network changes. The mechanism of the present invention allows for dynamic generation of groups in response to receiving a request for a group containing certain attributes. This mechanism allows for groups to be generated on non-preexisting data. Non-preexisting data is data that may be added to a database after the database has been initially populated with data. In other words, new attributes may be added to the database after the database has been used to provide groups in response to requests. Accordingly, subsequent requests for groups may result in generation of groups using the new attributes.

For example, the groups may be used for installing software based on various attributes of computers within a network. Different groups may require different installation procedures. Further, policy based management of the network may be applied to grouping using the mechanism of the present invention.

For example, an operator may identify a group of machines as a group of DNS servers. With this grouping, the servers may be quickly identified if routing problems occur. In addition, the operator also may notice a computer that should be in the group or a computer exists in the group, which should not be in the group. With these groups, actions, such as the status of a set of print servers may be identified. Other types of data collection and polling may be performed on these groups. By allowing the use of new attributes in generating groups, the mechanism of the present invention allows for more flexibility in managing network data processing systems.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for grouping based on attributes, the method comprising:
sending messages indicating an availability of a set of attributes relating to data processing systems in which the attributes are used to create groups;
receiving a request from a requester to generate a group using selected attributes from the set of attributes;
dynamically generating a group based on the selected attributes; and
returning the group to the requester.

2. The method of claim 1, wherein the groups are at least one of application groups, user groups, and data processing system groups.

3. The method of claim 1, wherein the set of attributes include at least one of a processor type, processor clock speed, an amount of memory, memory type, bus system, bus clock speed, storage capacity, connection, video card specification, and operating system.

4. The method of claim 1, wherein the group identifies a set of data processing systems.

5. The method of claim 1, wherein the group is used to install software to members of the group.

6. The method of claim 1, wherein the requester is a software process in a data processing system used to request members of the group.

7. The method of claim 1, wherein the group is generated using non-preexisting data.

8. The method of claim 1, wherein the group is generated using meta-data describing attributes within the set of attributes.

9. A data processing system comprising:
a bus system;
a communications unit connected to the bus system;
a memory connected to the bus system, wherein the memory includes as set of instructions; and
a processing unit connected to the bus system, wherein the processing unit executes the set of instructions to send messages indicating a set of attributes relating to data processing systems on which groups are created; receive a request from a requester to generate a group using selected attributes from the set of attributes; dynamically generate a group based on the selected attributes; and return the group to the requester.

10. The data processing system of claim 9, wherein the bus system is a single bus.

11. The data processing system of claim 9, wherein the bus system includes a primary bus and a secondary bus.

12. The data processing system of claim 9, wherein the processing unit includes a plurality of processors.

13. The data processing system of claim 9, wherein the communications unit is one of a modem and Ethernet adapter.

14. A data processing system for grouping based on attributes, the data processing system comprising:
sending means for sending messages indicating an availability of a set of attributes relating to data processing systems in which the attributes are used to create groups;
receiving means for receiving a request from a requester to generate a group using selected attributes from the set of attributes;
dynamically generating means for dynamically generating a group based on the selected attributes; and
returning means for returning the group to the requester.

15. The data processing system of claim 14, wherein the groups are at least one of application groups, user groups, and data processing system groups.

16. The data processing system of claim 14, wherein the set of attributes include at least one of a processor type, processor clock speed, an amount of memory, memory type, bus system, bus clock speed, storage capacity, connection, video card specification, and operating system.

17. The data processing system of claim 14, wherein the group identifies a set of data processing systems.

18. The data processing system of claim 14, wherein the group is used to install software to members of the group.

19. The data processing system of claim 14, wherein the requester is a software process in a data processing system used to request members of the group.

20. The data processing system of claim 14, wherein the group is generated using non-preexisting data.

21. A computer program product in a computer readable medium for grouping based on attributes, the computer program product comprising:
first instructions for sending messages indicating an availability of a set of attributes relating to data processing systems in which the attributes are used to create groups;
second instructions for receiving a request from a requester to generate a group using selected attributes from the set of attributes;
third instructions for dynamically generating a group based on the selected attributes; and
fourth instructions for returning the group to the requester.

22. The computer program product of claim 21, wherein the groups are at least one of application groups, user groups, and data processing system groups.

23. The computer program product of claim 21, wherein the set of attributes include at least one of a processor type, processor clock speed, an amount of memory, memory type, bus system, bus clock speed, storage capacity, connection, video card specification, and operating system.

24. The computer program product of claim 21, wherein the group identifies a set of data processing systems.

25. The computer program product of claim 21, wherein the group is used to install software to members of the group.

26. The computer program product of claim 21, wherein the requester is a software process in a data processing system used to request members of the group.

27. The data processing system of claim 21, wherein the group is generated using non-preexisting data.
